(19) United States
(12) Patent Application Publication
(10) Pub. No.: US 2004/0004965 A1
(43) Pub. Date: Jan. 8, 2004

(54) Dynamic provisioning of DSL services

(76) Inventors: Weijing Chen, Austin, TX (US); Keith Joseph Allen, Austin, TX (US)

Correspondence Address: GREENBLUM & BERNSTEIN, P.L.C., 1950 ROLAND CLARKE PLACE, RESTON, VA, 20191, US

(21) Appl. No.: 10/187,374

(22) Filed: Jul. 2, 2002

(51) Int. Cl. H04L 12/28

(52) U.S. Cl. 370/395.2; 370/352; 370/466

(57) ABSTRACT

A subscriber dynamically selects an Internet protocol (IP) service provider. In response to the selection, a digital subscriber line (DSL) modem establishes a switched virtual circuit (SVC) connection from the subscriber to the selected service provider across an asynchronous transfer mode (ATM) network. After the SVC has been established, the modem formats IP data, received from the subscriber, into ATM cells. The ATM cells are forwarded from the DSL modem, via the SVC, to a router associated with the selected service provider. The router formats the ATM cells into IP packets and forwards the IP packets to the selected service provider. Thus, the subscriber has a dynamically established connection to the selected service provider that can be used for IP traffic.

### BACKGROUND OF THE INVENTION

1. Field of the Invention

The present invention relates to the field of telecommunications. More particularly, the present invention relates to dynamically establishing broadband Internet protocol (IP) connections over a switched network.

2. Background Information

Network carriers are currently providing broadband access services to a large number of subscribers using asynchronous transfer mode (ATM) and digital subscriber lines (DSL). Under the current paradigm, subscribers connect to a single Internet service provider (ISP) using a pre-existing static point-to-point or “nailed up” connection, e.g., a permanent virtual circuit (PVC). The pre-existing connection, e.g., the PVC, is established using administrative systems internal to the carrier. Once the connection has been established the subscriber can communicate to the ISP, via the connection, using various bridging or routing approaches, typically point-to-point protocol (PPP) or point-to-point protocol over Ethernet (PPoE).

However, PPP and PPoE cannot dynamically establish a session to each possible ISP that a subscriber might like to access. Rather, PPP relies on a static connection that must be provisioned by the network carriers. The provisioning requires a subscriber to contact the network carrier and place an order, the implementation of which imposes a large administrative burden. Thus, a subscriber cannot easily change Internet service providers (ISPs) or even the speed at which the subscriber connects to an ISP.

It would be desirable to have a system that permits a subscriber to connect to any ISP at any time, without intervention of the network carrier.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawings, and in which:

FIG. 1 is a block diagram showing an exemplary network infrastructure, according to an aspect of the present invention; and

FIG. 2 is a flowchart illustrating dynamic establishment of a connection to a subscriber selected destination, according to an aspect of the present invention.

### DETAILED DESCRIPTION OF EMBODIMENTS

The present invention relates to dynamically establishing a connection to a destination that a subscriber has selected, without requiring network carrier intervention.

In view of the above, the present invention through one or more of its various aspects and/or embodiments is presented to accomplish one or more objectives and advantages, such as those noted below.

A method is provided for dynamically establishing a session from a subscriber to a selected Internet protocol (IP) service provider across an asynchronous transfer mode (ATM) network. The method includes receiving an address of the selected service provider at a digital subscriber line access multiplexer (DSLAM), and dynamically establishing a switched virtual circuit (SVC) connection to a router associated with the selected service provider. The method also includes receiving IP data formatted into ATM cells, at the DSLAM, and forwarding the data over the dynamically established SVC connection to create a connection that carries IP traffic. The IP traffic is forwarded over the created connection.

According to an aspect of the present invention, the method also includes receiving from the subscriber the address at a digital subscriber line (DSL) modem, and formatting the IP data into ATM cells at the DSL modem. The method may further include formatting the ATM cells into IP packets, at the router, and forwarding the IP packets to the selected service provider. The method may also include validating an originating address associated with the subscriber at the DSLAM and terminating processing when the originating address is not validated. In one embodiment, the receiving includes receiving a SETUP message and/or a connection speed. The method may also tear down the SVC connection.

A method is provided for dynamically establishing a session from a subscriber to a selected Internet protocol (IP) service provider across an asynchronous transfer mode (ATM) network. The method includes receiving from the subscriber an address of the selected service provider at a digital subscriber line (DSL) modem, and dynamically establishing a switched virtual circuit (SVC) connection from the DSL modem, via the ATM network, to a router associated with the selected service provider. The method also includes formatting IP data, received from the subscriber, into ATM cells at the DSL modem; forwarding the ATM cells from the DSL modem, via the SVC, to the router; formatting the ATM cells into IP packets, at the router, and forwarding the IP packets to the selected service provider. The method may also include validating, at the router, that the subscriber is a subscriber of the IP service provider.

A system is provided for dynamically establishing a session from a subscriber to a selected Internet protocol (IP) service provider. The system includes a digital subscriber line access multiplexer (DSLAM) that receives an address of the selected service provider, and an asynchronous transfer mode (ATM) network through which a switched virtual circuit (SVC) connection is dynamically established, based on the address. IP data formatted into ATM cells is forwarded from the DSLAM via the dynamically established SVC connection, creating an IP connection that the subscriber uses to communicate to the selected IP service provider.

In an aspect of the present invention, a digital subscriber line (DSL) modem is provided. The modem receives the address from the subscriber, and formats the IP data into ATM cells. The system may also include a router that formats the ATM cells into IP packets and forwards the IP packets to the selected service provider.

In one embodiment, the DSLAM validates an originating address associated with the subscriber. The DSLAM may receive the address in a SETUP message. The DSLAM may also receive a subscriber selected connection speed.

According to an aspect of the present invention, signalling embodied on a propagation medium dynamically establishes a session from a subscriber to a selected Internet protocol (IP) service provider across an asynchronous transfer mode (ATM) network. The signalling includes a SETUP signal and an ATM signal. The SETUP signal carries an address of the selected service provider that dynamically establishes a switched virtual circuit (SVC) connection across the ATM network to a router associated with the selected service provider. The ATM signal carries IP data formatted into ATM cells creating an IP connection that the subscriber uses to communicate to the selected IP service provider. The SETUP signal and the ATM signal are both received from a digital subscriber line (DSL) modem.

The signalling may also include an IP signal carrying ATM cells formatted into IP packets, the IP signal being forwarded from the router to the selected service provider. In one embodiment, the SETUP signal complies with UNI 4.0. The ATM signal may be formatted according to RFC 1483. A validation signal may be provided for validating the subscriber. In addition, a tear down signal may be provided for tearing down the SVC connection.

The various aspects and embodiments of the present invention are described in detail below.

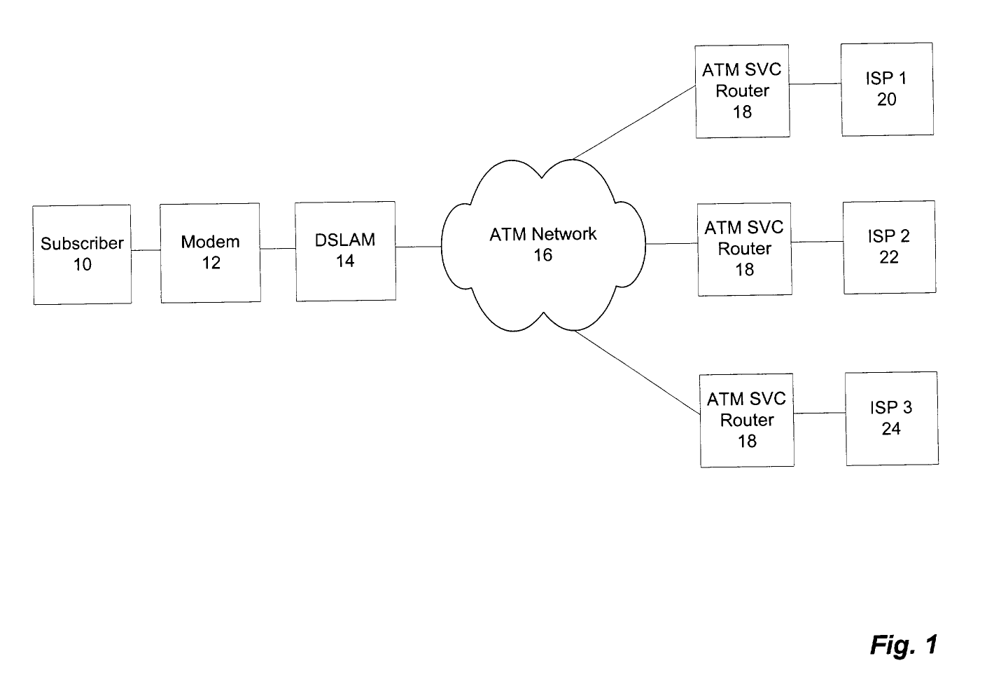

FIG. 1 is a block diagram depicting an exemplary network infrastructure in which the present invention operates. A subscriber's computer 10 is connected to a DSL modem 12 at the subscriber's premises. Although only a single subscriber is shown in FIG. 1, the present invention contemplates multiple subscribers. The diagram shows only a single subscriber to simplify explanation of the present invention.

The DSL modem 12 is assigned an ATM address by a network carrier. An exemplary DSL modem is the SpeedStream 5360 DSL Model, available from Efficient Networks, Inc. of Dallas Tex. The DSL modem 12 connects to a digital subscriber line access multiplexer (DSLAM) 14 using a pre-existing digital subscriber line. The DSLAM 14 is connected to a high speed network, e.g., an ATM network. In one embodiment, the DSLAM 14 also functions as an ATM switch and connects directly to the ATM network 16. In another embodiment, the DSLAM 14 connects to an ATM edge switch, which operates as a gateway into the ATM network 16. Although the following description refers only to ATM, any high speed connection oriented network can be substituted for the ATM network.

The ATM network includes a number of ATM switches (not shown). Exemplary switches include the Alcatel 7670 Routing Switch Platform, available from Compagnie Financiére Alcatel of Paris, France. As mentioned above, the DSLAM 14 may include ATM switch functionality or alternatively, may be collocated with one of the ATM switches. An exemplary DSLAM 14 that includes ATM functionality is the Alcatel 7300 Advanced Services Access Manager, available from Compagnie Financiére Alcatel of Paris, France.

An edge ATM switch of the ATM network 16 connects to a service provider's ATM SVC router 18, which is also assigned an ATM address by the network carrier. An exemplary ATM SVC router 18 is an SMS 1800, available from Redback Networks Inc. of San Jose, Calif. Each ATM SVC router 18 connects to a service provider, such as an Internet service provider 20, an Internet service provider 22, or an Internet service provider 24. The connection to the service provider 20, 22, 24 is via a local connection, such as an Ethernet connection.

According to an aspect of the present invention the subscriber 10 can dynamically select an ISP 20, 22, 24 (or any other service provider); or the subscriber 10 may dynamically select the connection speed. In order to dynamically select, the subscriber 10 enters an address associated with the selected ISP 20, 22, 24 (or speed) on the subscriber's computer 10 and based on the entered address, the modem 12 connects to the desired destination.

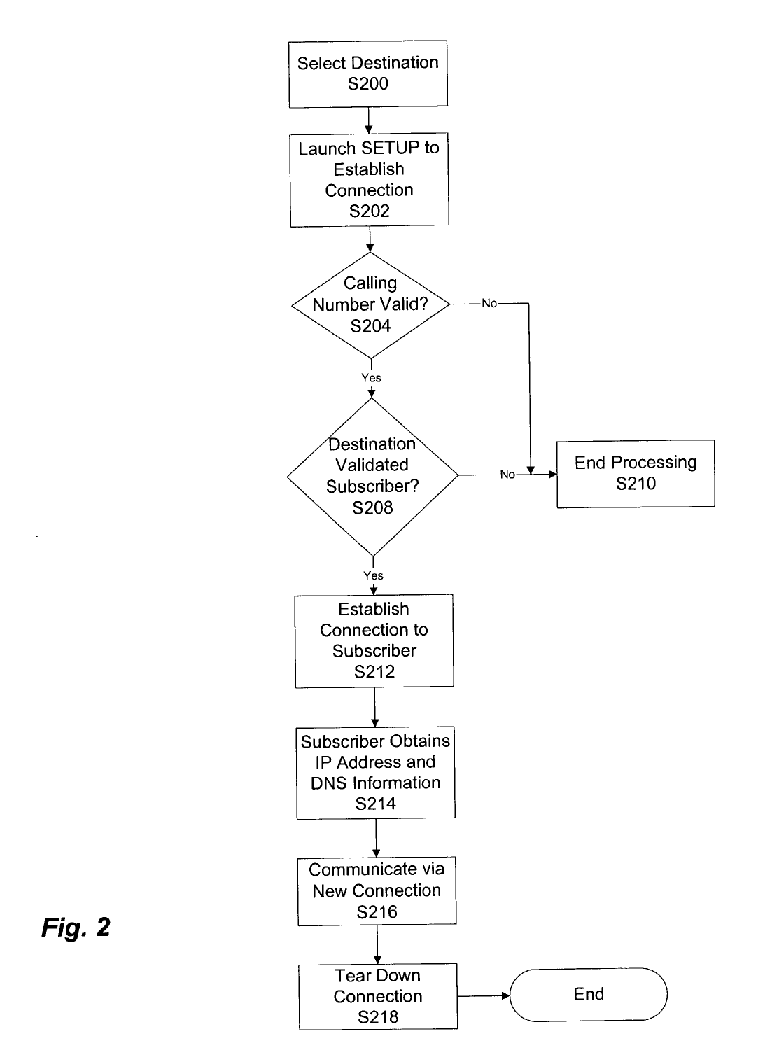

Description of the connection process is now provided with respect to FIG. 2. Initially, the subscriber 10 must obtain the ATM address of the ATM SVC router 18 of the selected ISP 20, shown at step S200. In the following example, the subscriber 10 selects the ISP 20, although any of the ISPs 20, 22, 24, may be selected. The subscriber 10 sends the address to the modem 12.

The subscriber 10 can also select Quality of Service parameters for the connection, such as the type (e.g., unspecified bit rate (UBR) or variable bit rate (VBR)) and the speed of the connection. These parameters could be included in the SETUP message when it is sent to the network 16. The connection is set up based on these parameters, i.e., all of the ATM switches in the path of the connection allocate resources in accordance with the requirements. The ISP 20 receives the connection speed parameter, ensuring that the ISP 20 is aware of the speed of the connection when the connection arrives. The ISP 20 could charge a usage based fee based on connect time and the speed. Alternatively, the ISP 20 could have tiered pricing. In this case, if the subscriber connects at a speed greater than allowed by the subscriber's tier, the connection could be rejected and the ISP 20 could request the subscriber to connect at a lower speed. The ISP 20 could charge more instead.

Once the address is received by the modem 12, at step S202 the modem 12 launches a SETUP message using a protocol, such as Q2.931 or User-Network Interface (UNI) 4.0, to establish a switched virtual circuit (SVC) connection. Details of ITU-T Recommendation Q.2931 can be found in the ITU-T document entitled “Broadband Integrated Services Digital Network (B-ISDN)—Digital Subscriber Signalling System No. 2 (DSS 2)—User-Network Interface (UNI) Layer 3 Specification for Basic Call/Connection Control,” published in February 1995, the disclosure of which is expressly incorporated herein by reference in its entirety. Details of UNI 4.0 can be found in the ATM Forum document entitled “ATM User-Network Interface (UNI) Signalling Specification Version 4.0,” document number af-sig-0061.000, published in July 1996, the disclosure of which is expressly incorporated herein by reference in its entirety.

To set up the SVC, the SETUP message travels across the DSL channel from the modem 12 to the DSLAM 14. The DSLAM 14 (or in an alternate embodiment, a network provider's ATM switch) checks whether the address associated with the modem 12 is assigned to the calling line by validating the ATM address in the CallingPartyNumber field of the SETUP message. The validation helps to prevent spoofing.

If the address is determined to be invalid at step S204, the processing is terminated at step S210. In an alternative embodiment, the DSLAM 14 replaces the invalid address with a default address corresponding to the modem 12 and processing continues as described below. On the other hand, if the calling number is determined to be valid at step S204, the call is routed through the ATM network 16, in a known manner, to the ATM SVC router 18 associated with the selected destination 20.

The ATM SVC router 18 confirms that the calling party is a subscriber, at step S208, by validating the address of the modem in a database of subscriber addresses. Multiple embodiments are now described for authenticating the subscriber. In one embodiment, the CallingPartyNumber is used to authenticate the user. In another embodiment, the subscriber 10 sends his user ID and password to the modem 12 when sending the ISP address. The modem 12 then includes this information in the SETUP message sent to the ATM network 16, in a User-to-User Signalling Information Element of the SETUP message. This information element allows a user to send a small amount of data to the user on the other end of the connection. The signalling network 16 transports this data end-to-end between users without processing it. In this case, the “users” of the ATM network are the modem 12 and the ATM SVC router 18. When the ATM SVC router 18 receives the SETUP message, the router 18 looks in the User-to-User Signalling Information Element for the authentication information, and checks this against a Radius server or such. If the information from the information element matches the information in the server, the call is accepted and the process continues as described below.

In an alternative embodiment, the ATM SVC router 18 simply accepts all calls, regardless of their calling party number, and expects the establishment of a PPP session, which includes the authentication of the user. No IP traffic would be accepted except over the established PPP session.

If the subscriber is not validated, processing ends at step S210. If the subscriber is validated, a connection is established between the ATM SVC router 18 and the modem 12. In one embodiment, the connection is a standard unspecified bit rate (UBR) SVC.

The connection establishment is now described in more detail. Initially, the DSL modem 12 sends a SETUP message and the DSLAM 14 connected to the modem 12 responds with a SETUP ACK message. The DSLAM 14 then sends a private network to network interface (PNNI) message to the switches in the ATM network 16 necessary for routing the call to the ATM SVC router 18. Once the message arrives at the switch serving the ATM SVC router 18, the switch serving the ATM SVC router 18 sends the SETUP message to ATM SVC router 18. The ATM SVC router 18 responds with a CONNECT or REJECT message, depending on whether the call is accepted, e.g., when the subscriber is validated.

Assuming a CONNECT message is sent, the CONNECT message causes a PNNI message to traverse the ATM network 16 back to the DSLAM 14. The DSLAM 14 forwards the CONNECT message to the modem 12 to inform the modem 12 that the connection has been established. Thus, the DSL modem 12 has an ATM connection to the ATM SVC router 18 associated with the selected ISP 20.

Once the connection has been established between the modem 12 and the selected ATM SVC router 18, the modem 12 sets up an IP-based connection (e.g., based upon RFC 1483R) over the established SVC. In other words, the modem 12 takes IP packets received from the subscriber 10 and formats the packets into ATM cells in accordance with RFC 1483R entitled “Multiprotocol Encapsulation over ATM adaptation layer 5 (AAL5).”

More specifically two methodologies may be employed. The first approach formats the entire Ethernet frame containing the IP packet frame into cells, and sends the cells over the SVC. This approach is referred to as 1483-bridged, or 1483B, because the data link layer (Ethernet) information is transmitted over ATM, which is how bridging devices work. In the second approach, the Ethernet frame is discarded and only the IP data is formatted into cells and sent over the ATM SVC. The second approach is referred to as 1483-routed, or 1483R. More information about RFC 1483 is provided on the IETF web site at http://www.ietf.org/rfc/rfc1483.txt?number=1483, the disclosure of which is expressly incorporated herein by reference in its entirety. The ATM SVC router 18 receives the cells and converts them into packets for transmission to the ISP 20, in accordance with the same methodology.

Using the IP-based connection, normal processing with the ISP commences at step S214. For example, the subscriber 10 obtains its IP address and domain name system (DNS) information from the ISP through dynamic host configuration protocol (DHCP) over the IP connection. After normal setup processing, the subscriber 10 has an Internet session through the selected ISP and communications may occur over the connection, at step S216.

The connection remains as long as the modem 12 stays powered up, even if the subscriber's computer 10 is powered off. If the computer 10 is powered down, the normal boot up processing (step S214) is repeated when the computer powers up and subsequently, communications may occur over the connection.

The connection can be torn down, at step S218 in response to either the subscriber's request, or in response to the ISP's request. The ISP 20 may tear down the connection, for example, when inactivity on the connection exceeds a predetermined time.

Thus, according to the present invention a subscriber can dynamically connect to a selected IP service provider via an SVC. Once the SVC is established, the IP packets are formatted into ATM cells for transmission across the ATM network. A router associated with the selected service provider reformats the cells into IP packets. Consequently, SVCs can be used for IP traffic for accessing an IP service provider.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium, e.g., a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for signalling and packet-switched network transmission (e.g., UNI 4.0, Q.2931, RFC 1483) and public telephone networks (e.g., ATM, DSL) represent examples of the state of the art. Such standards are periodically superseded by faster or more efficient equivalents having essentially the same functions. Accordingly, replacement standards and protocols having the same functions are considered equivalents.

What is claimed:

1. A method for dynamically establishing a session from a subscriber to a selected Internet protocol (IP) service provider across an asynchronous transfer mode (ATM) network, comprising:
receiving an address of the selected service provider at a digital subscriber line access multiplexer (DSLAM);
dynamically establishing a switched virtual circuit (SVC) connection to a router associated with the selected service provider;
receiving IP data formatted into ATM cells, at the DSLAM, and forwarding the data over the dynamically established SVC connection, creating a connection that carries IP traffic; and
forwarding IP traffic over the created connection.

2. The method for dynamically establishing the session from the subscriber to the selected IP service provider across the asynchronous transfer mode (ATM) network according to claim 1, further comprising receiving from the subscriber the address at a digital subscriber line (DSL) modem, and formatting the IP data into ATM cells at the DSL modem.

3. The method for dynamically establishing the session from the subscriber to the selected IP service provider across the asynchronous transfer mode (ATM) network according to claim 1, further comprising formatting the ATM cells into IP packets, at the router, and forwarding the IP packets to the selected service provider.

4. The method for dynamically establishing the session from the subscriber to the selected IP service provider across the asynchronous transfer mode (ATM) network according to claim 1, further comprising validating an originating address associated with the subscriber at the DSLAM.

5. The method for dynamically establishing the session from the subscriber to the selected IP service provider across the asynchronous transfer mode (ATM) network according to claim 4, further comprising terminating processing when the originating address is not validated.

6. The method for dynamically establishing the session from the subscriber to the selected IP service provider across the asynchronous transfer mode (ATM) network according to claim 1, in which the receiving further comprises receiving a SETUP message.

7. The method for dynamically establishing the session from a subscriber to the selected IP service provider across the asynchronous transfer mode (ATM) network according to claim 1, further comprising tearing down the SVC connection.

8. The method for dynamically establishing the session from a subscriber to the selected IP service provider across the asynchronous transfer mode (ATM) network according to claim 1, in which receiving the address further comprises receiving a subscriber selected connection speed.

9. A method for dynamically establishing a session from a subscriber to a selected Internet protocol (IP) service provider across an asynchronous transfer mode (ATM) network, comprising:
receiving from the subscriber an address of the selected service provider at a digital subscriber line (DSL) modem;
dynamically establishing a switched virtual circuit (SVC) connection from the DSL modem, via the ATM network, to a router associated with the selected service provider;
formatting IP data, received from the subscriber, into ATM cells at the DSL modem;
forwarding the ATM cells from the DSL modem, via the SVC, to the router; and
formatting the ATM cells into IP packets, at the router, and forwarding the IP packets to the selected service provider.

10. The method for dynamically establishing the session from the subscriber to the selected IP service provider across the asynchronous transfer mode (ATM) network according to claim 9, further comprising validating, at the router, that the subscriber is a subscriber of the IP service provider.

11. A system for dynamically establishing a session from a subscriber to a selected Internet protocol (IP) service provider, comprising:
a digital subscriber line access multiplexer (DSLAM) that receives an address of the selected service provider; and
an asynchronous transfer mode (ATM) network through which a switched virtual circuit (SVC) connection is dynamically established, based on the address;
wherein IP data formatted into ATM cells is forwarded from the DSLAM via the dynamically established SVC connection, creating an IP connection that the subscriber uses to communicate to the selected IP service provider.

12. The system for dynamically establishing the session from the subscriber to the selected Internet protocol (IP) service provider according to claim 11, further comprising a digital subscriber line (DSL) modem that receives the address from the subscriber, and formats the IP data into ATM cells.

13. The system for dynamically establishing the session from the subscriber to the selected Internet protocol (IP) service provider according to claim 11, further comprising a router that formats the ATM cells into IP packets and forwards the IP packets to the selected service provider.

14. The system for dynamically establishing the session from the subscriber to the selected Internet protocol (IP) service provider according to claim 11, in which the DSLAM validates an originating address associated with the subscriber.

15. The system for dynamically establishing the session from the subscriber to the selected Internet protocol (IP) service provider according to claim 11, in which the DSLAM receives the address in a SETUP message.

16. The system for dynamically establishing the session from the subscriber to the selected Internet protocol (IP) service provider according to claim 11, in which the DSLAM further receives a subscriber selected connection speed.

17. Signalling embodied on a propagation medium for dynamically establishing a session from a subscriber to a selected Internet protocol (IP) service provider across an asynchronous transfer mode (ATM) network, comprising:
a SETUP signal comprising an address of the selected service provider that dynamically establishes a switched virtual circuit (SVC) connection across the ATM network to a router associated with the selected service provider; and
an ATM signal comprising IP data formatted into ATM cells creating an IP connection that the subscriber uses to communicate to the selected IP service provider,
wherein the SETUP signal and the ATM signal are received from a digital subscriber line (DSL) modem.

18. The signalling for dynamically establishing the session from the subscriber to the selected IP service provider across the asynchronous transfer mode (ATM) network according to claim 17, further comprising an IP signal comprising the ATM cells formatted into IP packets, the IP signal being forwarded from the router to the selected service provider.

19. The signalling for dynamically establishing the session from the subscriber to the selected IP service provider across the asynchronous transfer mode (ATM) network according to claim 17, in which the SETUP signal complies with UNI 4.0.

20. The signalling for dynamically establishing the session from the subscriber to the selected IP service provider across the asynchronous transfer mode (ATM) network according to claim 17, in which the ATM signal is formatted according to RFC 1483.

21. The signalling for dynamically establishing the session from the subscriber to the selected IP service provider across the asynchronous transfer mode (ATM) network according to claim 17, further comprising a validation signal that validates the subscriber.

22. The signalling for dynamically establishing the session from the subscriber to the selected IP service provider across the asynchronous transfer mode (ATM) network according to claim 17, further comprising a tear down signal that tears down the SVC connection.
